(19) United States
(12) Patent Application Publication
(10) Pub. No.: US 2009/0188430 A1
(43) Pub. Date: Jul. 30, 2009

(54) Film Forming Apparatus, Matching Device, and Impedance Control Method

(75) Inventors: Satoshi Matsuda, Aichi (JP); Yuji Asahara, Kanagawa (JP); Hideo Yamakoshi, Kanagawa (JP); Seiji Goto, Aichi (JP)

Correspondence Address: BIRCH STEWART KOLASCH & BIRCH, PO BOX 747, FALLS CHURCH, VA, 22040-0747, US

(73) Assignees: Mitsubishi Heavy Industries Food & Packaging Machinery Co., Ltd., Nagoya-shi, AICHI (JP); Kirin Holdings kabushiki Kaisha, Chuo-ku, TOKYO (JP)

(21) Appl. No.: 11/883,580

(22) PCT Filed: Jan. 24, 2006
(86) PCT No.: PCT/JP2006/301022

§ 371 Date: Feb. 1, 2008

(30) Foreign Application Priority Data
Feb. 3, 2005 (JP) 2005-028307

(51) Int. Cl. B05C 11/00

(52) U.S. Cl. 118/708

(57) ABSTRACT

The present invention realizes an impedance control for avoiding the extinction of a plasma caused due to a sudden change in a load impedance, which may occur immediately after the plasma is generated. A film-forming apparatus of the present invention includes a power supply; a matching circuit; an electrode configured to receive electric power from the power supply through the matching circuit, and to generate a plasma inside a film forming chamber for accommodating a film forming target based on the electric power; and a control section configured to control an impedance of the matching circuit. The control section keeps the impedance of the matching circuit constant during a first period starting at a first time t₁ when the power supply starts to supply the electric power to the electrode, and controls the impedance of the matching circuit based on a reflected-wave power from the electrode for a second period starting at a second time t₂ when the first period ends.

### TECHNICAL FIELD

The present invention relates to a film-forming apparatus, a matching unit, and a matching circuit impedance control method. More specifically, the present invention relates to a film-forming apparatus that forms a film by a plasma discharge, a matching unit that is mounted on the film-forming apparatus, and a matching circuit impedance control method for controlling impedance of a matching circuit of a matching unit.

### BACKGROUND ART

A plasma CVD method that utilizes a plasma discharge generated by use of high-frequency power or microwave power is one of the techniques for forming a thin film at a low temperature. In the plasma CVD method, the plasma discharge can excite a chemical species that is related to forming a film, so that the temperature for forming the film can be set low.

One of essential techniques for the plasma CVD method is impedance matching in an electric power system that generates the plasma discharge. The impedance matching is important for generating the plasma surely as well as for stabilizing the plasma. In general, the impedance matching is performed by a matching unit that is connected between a power supply that generates a high-frequency power or a microwave power, and an electrode provided in a film-forming chamber. When a chamber itself that constitutes the film-forming chamber is used as the electrode, the matching unit is provided between the chamber and the power supply. The impedance matching can be achieved through properly controlling the impedance of the matching unit.

From such background, various techniques are proposed for properly controlling the impedance of the matching unit. For example, Japanese Laid Open Patent Application (JP-A-Heisei 9-260096) discloses a technique for surely generating the plasma through automatic impedance matching, even if the generation point of the plasma is shifted off due to a change in the impedance. The impedance matching method disclosed in this conventional example includes a step of searching an impedance matching point at which the plasma is generated by using preset impedance as a reference; a step of automatically moving the impedance matching point to a reference impedance matching point that is set in advance to generate a stable plasma discharge, when confirming that the plasma has been generated; and a step of automatically searching an impedance matching point for stabilizing the plasma discharge that is generated by using the shifted matching point as a reference. In such an impedance matching method, an optimum impedance matching for generation of the plasma is performed automatically. Thus, the plasma can be generated stably in a short time. In addition, it is possible to prevent non-generation of the plasma or extension of time necessary for generating the plasma, which may be caused due to a change the impedance within a processing chamber.

Japanese Laid Open Patent Application (JP-A-Heisei 8-96992) discloses a technique for stabilizing an operation of a plasma processing apparatus through optimizing control of an impedance matching unit. In an operation method of the plasma processing apparatus disclosed in this related art, the impedance of the matching unit is controlled for a preset time after film-forming is started, and then impedance of the matching unit is kept constant after the preset time has passed. Through employing such an operation method, input power for the plasma is stabilized since the impedance of the matching unit is not changed frequently. Therefore, the operation of the plasma processing apparatus is stabilized.

Japanese Laid Open Patent Application (JP-P2003-249454A) discloses a plasma processing method for properly dealing with a sudden change in load impedance caused due to an abnormal discharge during plasma processing. In the plasma processing method depicted in this related art, the impedance of the matching unit is adjusted only within an impedance variable range that is defined in advance. In such a plasma processing method, the impedance of the matching unit is not shifted largely from the normal impedance even if there is the sudden change in the load impedance. Therefore, it is possible to suppress problems such as promotion of the abnormal discharge and extension of the time necessary for the impedance to return to a proper value after the abnormal discharge is eliminated.

One of the factors to be considered for achieving the impedance matching is a control of the matching unit impedance immediately after the plasma is generated. Immediately after generation of the plasma, the load impedance (that is, the impedance formed by the plasma, electrode, and film-forming chamber) changes suddenly. When trying to match the impedance automatically in response to the sudden change of the load impedance, an operation of an impedance control system is diverged due to a delay in the matching operation, which may rather result in extinction of the plasma. The control of the matching unit impedance immediately after generation of the plasma is important for avoidance of the extinction of the plasma caused due to the sudden change in the load impedance.

Optimization of the matching unit impedance immediately after generation of the plasma is especially important in a case where a film-forming operation of a short-time such as several seconds is performed repeatedly a great number of times. For example, this is a case that a transmission prevention film is formed on a surface of a resin-made container such as a PET bottle so as to prevent transmissions of oxygen and carbon oxide. The resin-made container has a poor heat-resisting property. Thus, when the transmission prevention film is formed on the resin-made container, it is necessary to complete the formation of the transmission prevention film in a short time to prevent an increase in the temperature of the container.

One of the difficulties when a film-forming time is extremely short is that there is a limit in speeding up a response to the impedance control. In general, the impedance matching is performed by controlling the capacitance of a variable capacitor mechanically, so that there is a limit in speeding up the response to the impedance control. However, if the response to the impedance control is sufficiently quick in comparison with the film-forming time, a ratio of the time necessary for the control operation to be resolved after the sudden change of the load impedance with respect to the film-forming time becomes large. This is not preferable because it results in having an inhomogeneous characteristic in the film quantity.

In addition, in the impedance matching technique, it is important to take a measure for fluctuations of the load impedance when the film-forming is repeatedly performed a great number of times. When the film-forming is repeatedly performed a great number of times, the film is deposited in the film-forming chamber. Thus, the load impedance fluctuates gradually. The control of the impedance matching needed to cope with such a gradual fluctuation of the load impedance.

### DISCLOSURE OF INVENTION

The present invention has been accomplished from the above backgrounds.

An object of the present invention is to provide an impedance control for avoiding the extinction of a plasma caused due to a sudden change in a load impedance, which may occur immediately after the plasma is generated.

Another object of the present invention is to provide an impedance control for dealing with a gradual fluctuation of a load impedance, which is caused when the film-forming is repeatedly performed a great number of times.

According to one aspect of the present invention, a film-forming apparatus includes a power supply; a matching circuit; an electrode configured to receive electric power from the power supply through the matching circuit, and to generate plasma inside a film forming chamber for accommodating a film forming target based on the electric power; and a control section configured to control an impedance of the matching circuit. The control section keeps the impedance of the matching circuit constant during a first period starting at a first time when the power supply starts to supply the electric power to the electrode, and controls the impedance of the matching circuit based on a reflected-wave power from the electrode for a second period starting at a second time when the first period ends.

In such a film forming apparatus, the impedance of the matching circuit is fixed for a preset time after a supply of the electric power from the power supply to the electrode is started. Thus, a control operation does not diverge even if there is a sudden change in the load impedance. Therefore, it is possible to prevent an extinction of the plasma that is caused due to the divergence of the impedance control operation.

Preferably, the control section determines a next impedance in accordance with an end-time impedance as the impedance of the matching circuit at a third time when the power supply stops the supply of the electric power, and sets the impedance of the matching circuit to the next impedance. The power supply starts to supply the electric power to the electrode through the matching circuit from a fourth time after the impedance of the matching circuit is set to the next impedance. The end-time impedance as the impedance of the matching circuit at the third time is an excellent parameter to indicate the state of the film-forming chamber immediately before. Through setting the next impedance by using such an end-time impedance, it is possible to determine the next impedance properly by taking measurement to a gradual fluctuation of the load impedance caused due to the film-forming executed repeatedly a great number of times.

It is preferable for the control section to determine the impedance that is shifted from the end-time impedance by a predetermined offset amount as the next impedance.

Further, it is preferable for the control section to select one of a plurality of offset amounts in accordance with an external selection command, and to determine the impedance that is shifted from the end-time impedance by the selected offset amount, as the next impedance.

According to another aspect of the present invention, the matching unit includes: an input terminal connected to the power supply; an output terminal connected to the electrode for generating plasma inside the film-forming chamber; a matching circuit connected between the input terminal and the output terminal; and a control section configured to control the impedance of the matching circuit. The control section keeps the impedance of the matching circuit constant during a first period starting at a first time when a traveling-wave power that travels from an input terminal towards an output terminal exceeds a first threshold value, and controls the impedance of the matching circuit in accordance with a reflected-wave power that travels from the output terminal towards the input terminal during a second period starting at a second time when the first period ends. When the traveling-wave power becomes lower than a second threshold value after the second time, it is preferable for the control section to determine the next impedance in accordance with the end-time impedance as the impedance of the matching circuit at a third time when the traveling-wave power becomes lower than the second threshold value, and to set an impedance of the matching circuit as the next impedance. The first threshold value and the second threshold value may be consistent or inconsistent.

According to still another aspect of the present invention, an impedance control method is a method for controlling the impedance used for a film-forming apparatus which includes: a matching circuit; and an electrode that receives an electric power via the matching circuit and generates plasma inside a film-forming chamber to accommodate a film-forming target therein based on the electric power. The impedance control method includes steps of:

(A) setting the impedance of the matching circuit to a first impedance;

(B) starting a supply of the electric power to the electrode via the matching circuit, after step (A);

(C) keeping the impedance to a fixed value during a first period that starts at the start of the supply of the electric power; and

(D) controlling the impedance in accordance with a reflected-wave power from the electrode, during a second period following the first period.

According to yet another aspect of the present invention, the impedance control method includes:

(E) supplying the electric power to an electrode via a matching circuit during a second period starting at a second time;

(F) controlling the impedance of the matching circuit in accordance with the reflected-wave power from the electrode during the second period;

(G) stopping the supply of the electric power at a third time after the second time;

(H) determining a next impedance in accordance with an end-time impedance as the impedance of the matching circuit at the third time, and setting the impedance of the matching circuit as the next impedance; and

(I) starting the supply of the electric power to the electrode via the matching circuit from a fourth time that after the impedance of the matching circuit is set as the next impedance.

It is especially preferable for the film-forming apparatus, the matching unit, and the impedance control method described above to be applied to a resin-bottle coating apparatus that is used for coating resin bottles.

According to the present invention, it is possible to achieve an impedance control for avoiding the extinction of the plasma that is caused due to the sudden change in the load impedance, which may occur immediately after the plasma is generated.

Further, according to the present invention, it is possible to achieve an impedance control for dealing with a gradual fluctuation of the load impedance that is caused when the film-forming is performed repeatedly for a great number of times.

### BRIEF DESCRIPTION OF DRAWINGS

FIG. 1 is a conceptual diagram showing a first embodiment of a film-forming apparatus according to the present invention.

FIG. 2 is a block diagram showing a configuration of a matching unit according to the present embodiment.

FIG. 3 is a timing chart showing a film-forming procedure according to the present embodiment.

FIG. 4 is a block diagram showing another configuration of the matching unit according to the present embodiment.

### BEST MODE FOR CARRYING OUT THE INVENTION

Hereinafter, a film-forming apparatus according to embodiments of the present invention will be described in detail with reference to the accompanying drawings.

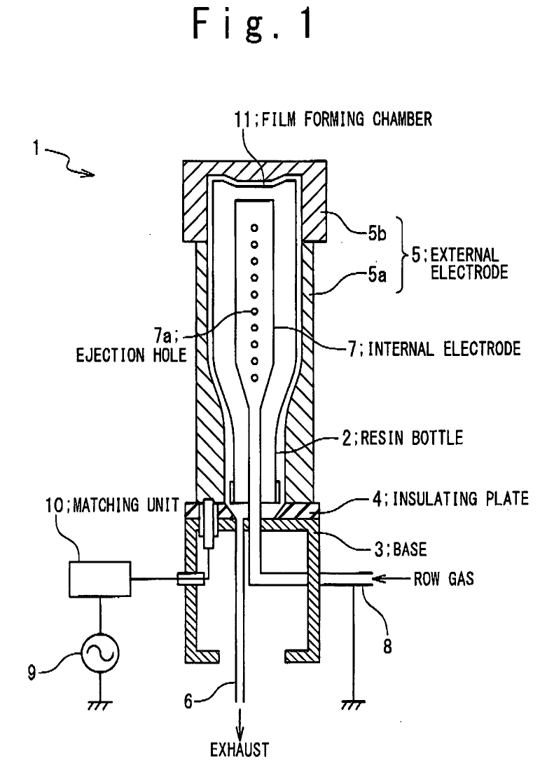

With reference to FIG. 1, the film-forming apparatus according to a first embodiment of the present invention is a resin-bottle coating apparatus 1 for forming a DLC (diamond like carbon) film on an inner face of a resin bottle 2 (for example, a PET (polyethylene terephthalate) bottle). The DLC film is a transmission preventing film for preventing oxygen and carbon oxide from transmitting through the resin bottle 2 undesirably. The resin bottle 2 in many cases has a characteristic of transmitting a very small amount of oxygen and carbon oxide. Therefore, it is important to form the transmission preventing film in order to maintain a quality of a drink, a pharmaceutical product, and other liquids that are enclosed in the resin bottle 2.

The resin-bottle coating apparatus 1 includes a base 3, an insulating plate 4, an external electrode 5, an exhaust pipe 6, an internal electrode 7, a raw as supply pipe 8, a high-frequency power supply 9, and a matching unit 10.

The insulating plate 4 is mounted on the base 3, and has a function of insulating the external electrode 5 from the base 3. The insulating plate 4 is formed of ceramics.

The external electrode 5 forms a film-forming chamber 11 for accommodating the resin bottle 2 as a film-forming target inside thereof. Further, the external electrode 5 functions to generate plasma in the film-forming chamber 11. The external electrode 5 is composed of a main body section 5a and a lid section 5b, which are both formed of metal. The film-forming chamber 1 can be closed and opened by separating and coupling the lid section 5b from and to the main body section 5a. The resin bottle 2 as a film-forming target is inserted into the film-forming chamber 11 from an opening that is provided by separating the lid section 5b from the main body section 5a. The main body section 5a of the external electrode 5 is connected to the high-frequency power supply 9 via the matching unit 10. When the DLC film is to be formed, a high-frequency power for generating the plasma is supplied from the high-frequency power supply 9 to the external electrode 5.

The exhaust pipe 6 is used for exhausting from the film-forming chamber 11. The exhaust pipe 6 is connected to a vacuum pump (not shown). When the resin bottle 2 is inserted into the film-forming chamber 11, the film-forming chamber 11 is exhausted by the vacuum pump via the exhaust pipe 6.

The internal electrode 7 is inserted into the film-forming chamber 11 that is formed by the external electrode 5. The internal electrode 7 is earthed, and a high voltage is generated between the external electrode 5 and the internal electrode 7 when a high-frequency power is supplied from the high-frequency power supply 9 to the external electrode 5. A plasma discharge is generated in the film-forming chamber 11 by the high voltage. The internal electrode 7 has a shape possible to be inserted into and taken out from the resin bottle 2, and the resin bottle 2 is guided into the film-forming chamber 11 in such a manner that the internal electrode 7 is enclosed inside the resin bottle 2. The internal electrode 7 is connected to the raw-gas supply pipe 8, and functions to introduce the raw gas supplied from the raw-gas supply pipe 8 into the film-forming chamber 11. More specifically, ejection holes 7a are formed to the internal electrode 7, and the raw gas is ejected to an inner face of the resin bottle 2 from the ejection holes 7a. When the raw gas is ejected under a state in which the plasma discharge is generated in the film-forming chamber 11, a DLC film is formed on the inner face of the resin bottle 2.

The high-frequency power supply 9 supplies the high-frequency power to the external electrode 5 for generating the plasma discharge. While the DLC film is formed, the high-frequency power supply 9 continuously supplies the high-frequency power to the external electrode 5.

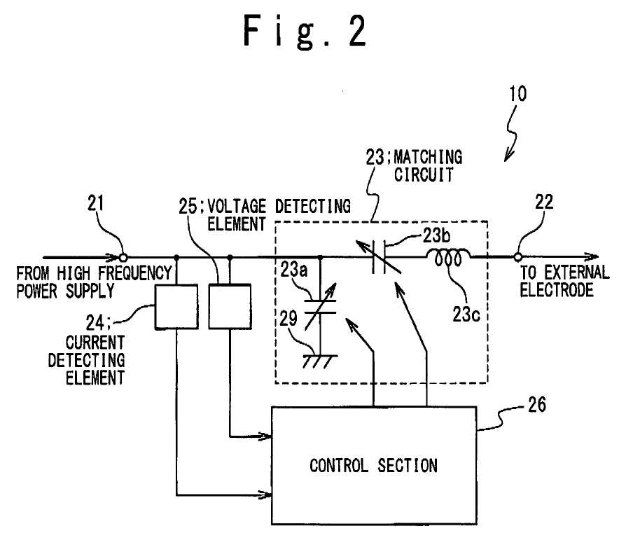

The matching unit 10 is connected between the external electrode 5 and the high-frequency power supply 9, and functions to achieve impedance matching therebetween. FIG. 2 shows a circuit configuration of the matching unit 10. The matching unit 10 includes an input terminal 21, an output terminal 22, a matching circuit 23, a current detecting element 24, a voltage detecting element 25, and a control section 26.

The input terminal 21 is connected to the high-frequency power supply 9, and the output terminal 22 is connected to the external electrode 5. The power outputted from the high-frequency power supply 9 is supplied to the input terminal 21, and is further supplied to the external electrode 5 from the output terminal 22. However, a part of the power supplied from the high-frequency power supply 9 to the external electrode 5 is reflected because of an unmatched impedance. The power traveling from the input terminal 21 towards the output terminal 5 is a power traveling from the high-frequency power supply 9 towards the external electrode 5, and is called a traveling-wave power hereinafter. Meanwhile, a power traveling from the output terminal 22 to the input terminal 21 is the power reflected by the external electrode 5, and is called a reflected-wave power hereinafter.

The matching circuit 23 includes a variable capacitor 23a that is connected in series between the input terminal 21 and a ground terminal 29; a variable capacitor 23b that is connected in series with the input terminal 21 between the input terminal 21 and the output terminal 22; and a coil 23c. The variable capacitors 23a and 23b can be adjust the capacitances thereof by moving the movable electrodes. The impedance of the matching circuit 23 is adjusted through adjusting the capacitances of the variable capacitors 23a and 23b.

The current detecting element 24 and the voltage detecting element 25 are used for measuring the traveling-wave power and the reflected-wave power. The current detecting element 24 measures an electric current that flows in the input terminal 21, and the voltage detecting element 25 measures the voltage of the input terminal 21. The measured current and voltage are outputted to the control section 26, which are used when the control section 26 calculates the traveling-wave power and the reflected-wave power.

The control section 26 calculates the traveling-wave power and the reflected-wave power from the current and the voltage measured by the current detecting element 24 and the voltage detecting element 25, and the capacitances of each of the variable capacitors 23a and 23b, that is, the impedance of the matching circuit 23 is controlled based on the traveling-wave power and the reflected-wave power. The traveling-wave power is used when the control section 26 detects an operation state of the high-frequent power supply 9. The control section 26 determines that the high-frequency power supply 9 has started to a supply the power to the external electrode 5, when the traveling-wave power increases to a value exceeding a prescribed threshold value. Thereafter, when the traveling-wave power decreases to a value below the prescribed threshold value, the control section 26 determines that the high-frequency power supply 9 has stopped the supply of the power to the external electrode 5. Meanwhile, the reflected-wave power is used for achieving an impedance matching between the external electrode 5 and the high-frequency power supply 9. The capacitance of each of the variable capacitors 23a and 23b is controlled in such a manner that the reflected-wave power becomes the minimum. Through controlling the capacitors 23a and 23b, the impedance matching between the external electrode 5 and the high-frequency power supply 9 can be achieved.

In order to improve an efficiency of the film-forming process, it is preferable to provide a plurality of such resin-bottle coating apparatuses 1 arranged on a same circumference of one film-forming line, and to perform film-forming on respective resin bottles successively by the plurality of resin-bottle coating apparatuses 1. In this case, the plurality of resin-bottle coating apparatuses 1 are circulated while being moved along the circumference, and each of the resin-bottle coating apparatuses 1 repeatedly performs the prescribed processes of supplying a bottle, forming a film, and outputting the bottle in synchronization with a process sequence in accompaniment with the circulation.

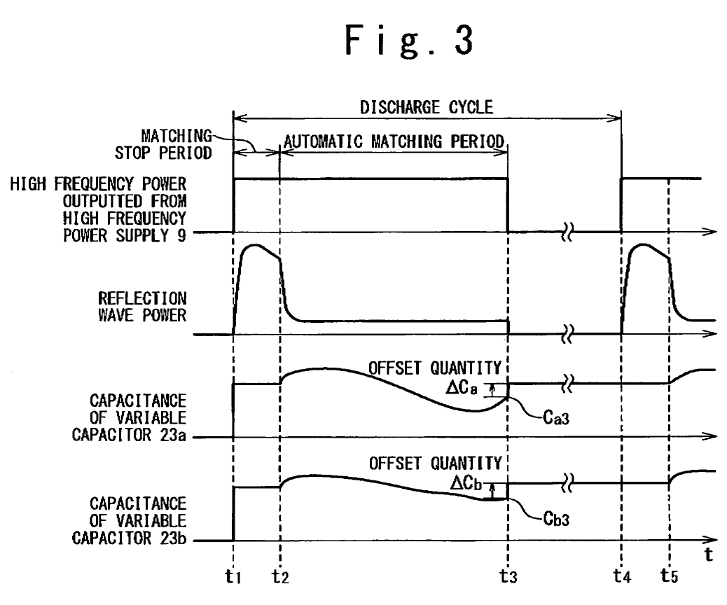

The film-forming process for forming the DLC film to the resin bottle 2 by the resin-bottle coating apparatus 1 constituted in the above-described manner will be described in detail with reference to FIG. 3.

There are two important points in the film-forming procedure in the first embodiment. One is that, as shown in FIG. 3, the impedance (that is, the capacitances of the variable capacitors 23a and 23b) of the matching circuit 23 is fixed immediately after a supply of the high-frequency power is started from the high-frequency power supply 9 to the external electrode 5, and an active control of the impedance of the matching circuit 23 is not performed. This is to avoid the extinction of the plasma caused due to the sudden change of the load impedance immediately after the plasma is generated. As described above, if the impedance of the matching circuit 23 is actively controlled immediately after the plasma is generated, the operation of the impedance control system is diverged due to a delay in the matching operation, which may rather result in the extinction of the plasma. In order to prevent the extinction of the plasma caused due to divergence of the operation of the impedance control system, the impedance of the matching circuit 23 is fixed for a prescribed time after the supply of the high-frequency power is started from the high-frequency power supply 9 to the external electrode 5. A period during which the impedance of the matching circuit 23 is fixed is called a matching stop period hereinafter.

It may be considered unpreferable not to perform the control of the impedance of the matching circuit 23 immediately after the supply of the high-frequency power is started, because it induces the unmatched impedance. However, such inconvenience can be avoided mostly by properly selecting the impedance of the matching circuit 23 during the matching stop period. Through selecting the impedance of the matching circuit 23 optimally, the reflected wave can be suppressed to a degree that is not considered inconvenient for forming the film, even though a perfect matching of the impedance cannot be achieved. Not to perform the control of the impedance of the matching circuit 23 during the matching stop period is rather effective for preventing the extinction of the plasma caused due to the sudden change of the load impedance.

However, from a viewpoint of supplying the high-frequency power, the power inputted to the plasma decreases since a perfect matching is not performed during the matching stop period. In order to supply the high-frequency power to the plasma sufficiently during a period for supplying the high-frequency power, it is required for a discharge stop period to be sufficiently short in comparison with an automatic matching period. For example, when an entire power supply period is 3.0 seconds, the matching stop period is set to be about 0.3 seconds.

The other important point is that, after ending the supply of the high-frequency power from the high-frequency power supply 9 to the external electrode 5, the impedance of the matching circuit 23 at the time of starting the next supply of the high-frequency power from the high-frequency power supply 9 to the external electrode 5 is determined to be shifted by a predetermined offset amount from the impedance of the matching circuit 23 at the point of time when the supply of the high-frequency power has been ended. In other words, after the next supply of the high-frequency power from the high-frequency power supply 9 to the external electrode 5 is ended once at time t₃, the impedance of the matching circuit 23 at time t₄ when the next supply of the high-frequency power is started is determined to be different from the impedance of the matching circuit 23 at time t₃ by a prescribed offset amount.

Such a control of the impedance of the matching circuit 23 is effective for dealing with a gradual fluctuation of the load impedance that is caused due to a change in a state of the film-forming chamber 11. As described above, in the first embodiment, the impedance of the matching unit 23 is not controlled during the matching stop period immediately after the supply of the high-frequency power is started. This generates a necessity to determine the impedance of the matching circuit 23 at the start of the supply of the high-frequency power to a value with which the plasma can be generated and the reflected-wave power can be suppressed to some extent. For this purpose, the impedance of the matching circuit 23 at the start of the supply of the high-frequency power may be set to a fixed value that is defined empirically. However, if the impedance of the matching circuit 23 at the start of the supply of the high-frequency power is a complete fixed value, it is not possible to deal with the gradual fluctuation of the load impedance. Therefore, in the first embodiment, the impedance of the matching circuit 23 at the start of the supply of the high-frequency power is determined based on the impedance of the matching circuit 23 when the supply of the high-frequency power is ended immediately therebefore. It is because the impedance of the matching circuit 23 at time t₃ when the supply of the high-frequency power is ended is one of the best parameters for reflecting a state of the film-forming chamber 11 at that point. Through determining the impedance of the matching circuit 23 at time t₄ when the next supply of the high-frequency power is started by giving the impedance of the matching circuit 23 at time t₃ when the supply of the high-frequency power is ended as the reference, it is possible to deal with the gradual fluctuation of the load impedance effectively.

For the amount of the offset, it is desirable to be a small amount for reducing the reflected power during the matching stop period of the next discharge cycle, considering that the impedance of the matching circuit 23 at time t₃ is the result of the control performed by an automatic matching operation to minimize a reflected power. For example, if the variable range of the impedance of the matching circuit 23 is 0-100%, a numerical value of several percent thereof is set as the offset amount.

The procedure for forming the DLC film will be described in a time-series manner.

Before starting to form the DLC film, the resin bottle 2 is guided into the film-forming chamber 11. Further, as shown in FIG. 3, the variable capacitors 23a and 23b are set to certain capacitance values.

The film-forming of the DLC film is started, when the raw gas is introduced into the film-forming chamber 11 and the supply of the high-frequency power from the high-frequency power supply 9 to the external electrode 5 is started. The time at which the supply of the high-frequency power from the high-frequency power supply 9 to the external electrode 5 is started is referred to as time t₁ in FIG. 3. The control section 26 for the matching unit 10 detects the start of the supply of the high-frequency power by sensing that the traveling-wave power has exceeded a prescribed threshold value.

The capacitance of each of the variable capacitors 23a and 23b, that is, the impedance of the matching circuit 23, is not actively controlled during the matching stop period that starts from time t₁. The control section 26 of the matching unit 10 fixes the capacitances of the variable capacitors 23a and 23b for a prescribed time after sensing that the supply of the high-frequency power is started. Even though the load impedance changes suddenly during the matching stop period, there is no control performed to respond to the sudden change of the load impedance. With this, the extinction of the plasma caused due to the sudden change of the load impedance can be avoided.

At time t₂ when the matching stop period ends, the control section 26 starts the control on the capacitances of the variable capacitors 23a and 23b in accordance with the reflected-wave power. The control section 26 actively controls the impedance of the matching circuit 23 so that the reflected-wave power becomes the minimum. A period during which the impedance of the matching circuit 23 is actively controlled is referred to as the automatic matching period in FIG. 3.

Thereafter, the high-frequency power supply 9 stops the supply of the high-frequency power at time t₃ that is after time t₂ in order to end forming the DLC film. The control section 26 of the matching unit 10 detects the stop of the supply of the high-frequency power by sensing that the traveling-wave power has decreased and become lower than the prescribed threshold value. Upon detecting that the supply of the high-frequency power is stopped, the control section 26 of the matching unit 10 shifts the capacitances of the variable capacitors 23a and 23b by a prescribed offset amount. That is, the control section 26 sets the capacitances of the variable capacitors 23a and 23b as Cₐ₃+ΔCₐ and C_{b3}+ΔC_{b}, respectively, if the capacitances of the variable capacitors 23a and 23b at time t₃ when the supply of the high-frequency power is stopped is defined as Cₐ₃ and C_{b3}, respectively.

Subsequently, the resin bottle 2 to which the DLC film is formed is taken out from the film-forming chamber 11, and a next resin bottle 2 for the DLC film to be formed is fed into the film-forming chamber 11.

Then, the DLC film is formed through the same process as described above. The capacitances of the variable capacitors 23a and 23b at time t₄ when the next supply of the high-frequency power is started are Cₐ₃+ΔCₐ and C_{b3}+ΔC_{b}, respectively. The fact that the capacitances of the variable capacitors 23a and 23b at time t₄ when the supply of the high-frequency power is started is determined based on the capacitances Cₐ₃ and C_{b3} of the variable capacitors 23a and 23b at time t₃ when the supply of the high-frequency power is stopped is effective for achieving the impedance matching optimally in accordance with a gradual fluctuation of the load impedance caused due to a change in a state of the film-forming chamber 11.

It is possible for the offset amounts ΔCₐ, ΔC_{b} of the variable capacitors 23a, 23b to be fixed values that are provided in advance.

The proper offset amounts ΔCₐ and ΔC_{b} are selected in a following manner, for example. A matching condition in which the reflected power becomes small is searched under a condition that the high-frequency power is supplied to the film-forming apparatus, the matching unit is manually operated, and the plasma is not generated. The matching positions on which the plasma is generated are defined as matching initial values Cₐᵢₙᵢ and C_{bini}. Alternatively, a matching condition in which the voltage imposed upon the electrode becomes high is searched under a condition that the high-frequency power is supplied to the film-forming apparatus, the matching unit is manually operated, and the plasma is not generated. The matching positions on which the plasma is generated are defined as matching initial values Cₐⁱⁿⁱ and C_{b}ⁱⁿⁱ.

The high-frequency power is supplied to the film-forming apparatus, the plasma is generated, and the matching unit is automatically operated to follow the impedance of the plasma so as to form a film for a prescribed time. The matching positions at the time of ending the discharge are defined as Cₐ^{end} and C_{b}^{end}.

Based on the data provided above, the offset amounts are selected as follows.

ΔCₐ=Cₐⁱⁿⁱ−Cₐ^{end}

ΔC_{b}=C_{b}ⁱⁿⁱ−C_{b}^{end}

The offset amounts are optimized by repeatedly forming the film further to be adjusted as ΔCₐ and ΔC_{b}, which provide a still smaller reflected power and a fine generation property for the plasma.

Shown below are examples of the offset amounts ΔCₐ and ΔC_{b} of the matching unit, when the film-forming (set uncoated bottle—vacuum exhaustion—plasma CVD—release air—take out bottle) is performed repeatedly in the DLC coating apparatus for PET bottles by the plasma CVD.

### [Film-Forming Condition]

PET bottle capacity: 350 ml
High-frequency power supply frequency: 13.56 MHz
High-frequency power: 700W

### Raw gas: Acetylene

Pressure when forming film: 100 mTorr
Offset amount

### ΔCₐ: −0.1 to −3.5%

### ΔC_{b}: 0.1 to 3.5%

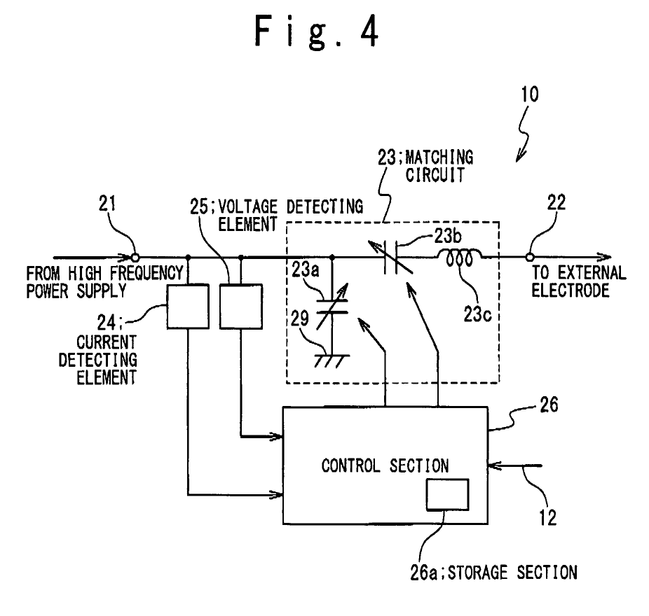

In the second embodiment, in order to properly determine the offset amounts ΔCₐ and ΔC_{b} in accordance with changes in material and shape of the resin bottle as a target for forming the film and changes in the film-forming condition of the DLC film, it is preferable to be able to select a pair of the offset amounts (ΔCₐ, ΔC_{b}) from a plurality of offset amount pairs (ΔCₐ^{α}, ΔC_{b}^{α}), (ΔCₐ^{β}, ΔC_{b}^{β}), (ΔCₐ^{γ}, ΔC_{b}^{γ}), - - - , which are provided in advance. In this case, as shown in FIG. 4, the control section 26 is provided with a storage section 26a for storing the plurality of offset amount pairs (ΔCₐ^{α}, ΔC_{b}^{α}), (ΔCₐ^{β}, ΔC_{b}^{β}), (ΔCₐ^{γ}, ΔC_{b}^{γ}), - - - . Further, a selection command 12 for selecting a pair of offset amounts is supplied from the outside. In accordance with the selection command 12, the control section 26 selects a single pair of offset amounts from the plurality of offset amount pairs (ΔCₐ^{α}, ΔC_{b}^{α}), (ΔCₐ^{β}, ΔC_{b}^{β}), (ΔCₐ^{γ}, ΔC_{b}^{γ}), - - - , and uses the selected pair of offset amounts for determining the capacitances of the variable capacitors 23a and 23b when starting the supply of the high-frequency power.

1. A film forming apparatus comprising:
a power supply;
a matching circuit;
an electrode configured to receive electric power from said power supply through said matching circuit, and to generate plasma inside a film forming chamber for accommodating a film forming target based on the electric power; and
a control section configured to control an impedance of said matching circuit,
wherein said control section keeps the impedance of said matching circuit constant during a first period starting at a first time when said power supply starts to supply the electric power to said electrode, and controls the impedance of said matching circuit based on a reflected-wave power from said electrode for a second period starting at a second time when the first period ends.

2. The film forming apparatus according to claim 1, wherein said power supply stops the supply of the electric power to at a third time after the second time,
said control section determines a next impedance based on an end-time impedance as the impedance of said matching circuit at the third time, and sets the impedance of said matching circuit to the next impedance, and
said power supply starts to supply the electric power to said electrode through said matching circuit from a fourth time after the impedance of said matching circuit is set to the next impedance.

3. The film forming apparatus according to claim 2, wherein said control section determines the impedance that is shifted from the end-time impedance by a predetermined offset amount as the next impedance.

4. The film forming apparatus according to claim 2, wherein said control section selects one of a plurality of offset amounts in response to an external selection command, and determines an impedance that is shifted from the end-time impedance by the selected offset amount as the next impedance.

5. The film forming apparatus according to claim 1, wherein said film forming target is accommodated in said film forming chamber during the first and second periods, and a row gas for a film to be formed on said film forming target is supplied into said film forming chamber.

6. The film forming apparatus according to claim 2, wherein said control section keeps the impedance of said matching circuit constant during a third period starting the fourth time,
said first target is accommodated in said film forming chamber during the first and second periods, and a row gas for a film to be formed on said first target is supplied into said film forming chamber, and
said second target different from said first target is accommodated in said film forming chamber during the third period, and a row gas for a film to be formed on said second target is supplied into said film forming chamber.

7. A film forming apparatus comprising:
a power supply;
a matching circuit;
an electrode configured to receive electric power from said power supply through said matching circuit, and to generate plasma inside a film forming chamber for accommodating a film forming target based on the electric power; and
a control section configured to control an impedance of said matching circuit,
wherein said control section controls the impedance of said matching circuit based on a reflected-wave power from said electrode for a second period starting at a second time,
said power supply stops the supply of the electric power at a third time after the second time,
said control section determines a next impedance based on an end-time impedance as the impedance of said matching circuit at the third time, and sets the impedance of said matching circuit to the next impedance, and
said power supply starts to supply the electric power to said electrode through said matching circuit from a fourth time after the impedance of said matching circuit is set to the next impedance.

8. The film forming apparatus according to claim 7, wherein said first target is accommodated in said film forming chamber during the second period, and a row gas for a film to be formed on said first target is supplied into said film forming chamber, and
said second target different from said first target is accommodated in said film forming chamber during a third period starting at the fourth time, and a row gas for a film to be formed on said second target is supplied into said film forming chamber.

9. A matching unit comprising:
an input terminal connected to a power supply;
an output terminal connected to an electrode used to generate plasma inside a film-forming chamber;
a matching circuit connected between said input terminal and said output terminal; and
a control section configured to control an impedance of said matching circuit,
wherein said control section keeps the impedance of said matching circuit constant during a first period starting at a first time when said traveling-wave power from said input terminal to said output terminal exceeds a first threshold value, and controls the impedance of said matching circuit based on a reflected-wave power from said output terminal to said input terminal in a second period starting at a second time when the first period ends.

10. The matching unit according to claim 9, wherein said control section determines a next impedance based on an end-time impedance as the impedance of said matching circuit at the third time when said traveling-wave power is lowered from a second threshold value after the second time, and sets the impedance of said matching circuit to the next impedance.

11. An impedance control method for a film forming apparatus which comprises a matching circuit, and an electrode configured to receive electric power through said matching circuit and to generate a plasma in a film forming chamber that accommodates a target based on said electric power, said impedance control method comprising:
(A) setting an impedance of the matching circuit to a first impedance;
(B) starting a supply of electric power to said electrode through said matching circuit, after said step (A);
(C) keeping the impedance to a predetermined value in a first period starting when the supply of the electric power is started; and
(D) controlling the impedance in response to a reflected-wave power from said electrode in a second period following the first period.
